(19) United States
(12) Patent Application Publication
(10) Pub. No.: US 2026/0298707 A1
(43) Pub. Date: Oct. 1, 2026

(54) SPECTROSCOPY APPARATUS AND METHODS

(71) Applicant: RENISHAW PLC, Wotton-under-Edge, Gloucestershire (GB)

(72) Inventor: Brian John Edward SMITH, Wotton-under-Edge (GB)

(73) Assignee: RENISHAW PLC, Wotton-under-Edge, Gloucestershire (GB)

(21) Appl. No.: 19/164,478

(22) PCT Filed: Mar. 15, 2024
(86) PCT No.: PCT/GB2024/050706

§ 371 Date: Sep. 11, 2025

(30) Foreign Application Priority Data
Mar. 16, 2023 (GB) 2303844.1

(51) Int. Cl. G01J 3/02; G01J 3/18; G01J 3/28; G01J 3/44

(52) U.S. Cl. CPC G01J 3/0235; G01J 3/0202; G01J 3/0291; G01J 3/18; G01J 3/2803; G01J 3/44; G01J 2003/2813

(57) ABSTRACT

A Raman spectroscopy apparatus including an optical input; an optic selector arranged to selectively locate a pair of optics selected from a set of different pairs such that the pair of optics disperses incoming light received by the optical input into a spectrum; and a photodetector arranged to detect the spectrum. Selecting a different pair of optics from the set changes the spectrum detectable by the photodetector.

### FIELD OF INVENTION

This invention concerns spectroscopy apparatus and methods. The invention has particular, but not exclusive application to spectroscopy apparatus useable across a wide range of wavenumbers, resolutions and dispersions, such as in Raman spectroscopy.

### BACKGROUND

The Raman Effect is a phenomenon in which a sample scatters incident light of a given frequency into a frequency spectrum, which has characteristic peaks caused by interaction of the incident light with the molecules making up the sample. Different molecular species have different characteristic Raman peaks, and so the effect can be used to analyse the molecular species present.

A prior Raman analysis apparatus is described in European Patent Application No. EP 0543578. A sample is illuminated by a laser beam, and the resulting Raman scattered light is analysed, and then detected. The detector may be a charge-coupled device (CCD) comprising a two-dimensional array of pixels. The analysis of the Raman spectrum may be carried out by a dispersive device such as a diffraction grating, which disperses the spectrum produced from a point or line on the sample across the width of the CCD. The apparatus may be arranged to disperse the spectrum widely across the CCD, to provide high spectral resolution.

For a CCD of a given width, however, only a part of the spectrum can then be detected at any one time. To acquire data from a wider spectrum, one possible method is to expose one part of the spectrum onto the CCD for a sufficient time, and then to read all of the data relating to that part of the spectrum from the CCD into a computer. Next, the diffraction grating is indexed to a new position, so that a second part of the spectrum is received by the CCD. Again, sufficient exposure time is allowed, and all the data from the second part of the spectrum is read into the computer. This process is repeated as often as necessary. Exposing the separate parts of the spectrum sequentially increases the time required to analyse the complete spectrum compared with a lower resolution system in which the whole spectrum of interest is dispersed more narrowly across the width of the CCD.

EP 0543578 discloses a further data acquisition method, wherein, at a given point in time, a Raman spectrum is dispersed along this column or row of a CCD detector. The spectrum is scanned along the column or row of pixels, synchronously with the shifting of the charge from one pixel to the next and reading out the data from the end pixel into a computer. After a short exposure time the computer commands the CCD to shift all the data by one pixel, whilst simultaneously commanding a turntable to index a grating by an amount equivalent to the spectral resolution between adjacent pixels.

Next, after a further short exposure time, the same length as previously, the charge in each pixel is again shifted into its neighbouring pixel and simultaneously the grating is again indexed by an amount equivalent to the spectral resolution between adjacent pixels. This process is repeated many times in order to acquire data from as wide a spectral range as desired.

However, to view certain wavenumbers of the spectrum, the diffraction grating must be located at an extreme angle (an angle close to 90° to the normal of the diffraction grating) to the incoming light beam. This is undesirable because to view a desired wavenumber range very large diffraction gratings may be required and possibly CCD lenses. For other wavenumber ranges, a very high angle to the output beam may be required, making this beam very narrow and underfilling the CCD lens which will compromise the quality of its focus. Other wavenumber ranges will not be obtainable at all.

U.S. Pat. No. 8,179,526 discloses spectroscopy apparatus wherein spectra from points in a line focus are dispersed in rows on a CCD detector, having a two-dimensional array of pixels. The line focus moves longitudinally in a direction Y relative to the sample. Simultaneously and synchronously, charge is shifted in a parallel direction Y′ within the CCD, so that data from a given point in the sample continues to accumulate. This ensures that the data from each sample point arises from illumination which is integrated along the line focus, and makes it easier to stitch the data together subsequently to form an image of the sample.

### SUMMARY OF INVENTION

According to a first aspect of the invention there is provided a spectroscopy apparatus comprising an optical input; an optic selector arranged to selectively locate a pair of optics selected from a set of different pairs such that the pair of optics disperses incoming light received by the optical input into a spectrum; and a photodetector arranged to detect the spectrum. Selecting a different pair of optics from the set may change the spectrum detectable by the photodetector (for the same incoming light). The different spectrum may be a shift in wavenumbers of the spectrum, a change in resolution of the spectrum and/or a change in dispersion of the spectrum.

Use of pairs of optics may avoid the need for a diffraction grating located at an extreme angle, whilst selecting the pair allows the apparatus to be used for a range of purposes where detection of different wavenumbers and/or detection of spectra at different resolutions and/or dispersions is required.

The photodetector may comprise an array of photodetector elements. The pair of optics may disperse the spectrum across the array of photodetector elements. The photodetector may comprise a two-dimensional array of photodetector elements and the pair of optics may disperse the spectrum across a row or column of the two-dimensional array.

The apparatus may comprise a computer arranged to receive separate data values from the photodetector, the data values recorded for different wavelengths of incoming light simultaneously incident on different photodetector elements of the photodetector, and associating each data value with a different wavenumber.

The apparatus may comprise a source for generating an excitation beam for illuminating a sample, wherein the optical input is arranged to receive Raman light generated from illumination of the sample with the excitation beam. The apparatus may comprise a laser for generating a laser beam for illuminating a sample, wherein the optical input is arranged to receive Raman light generated from illumination of the sample with the laser beam. The apparatus may comprise a Rayleigh filter for filtering out a laser wavelength of the laser beam from light delivered to the pair of optics. Accordingly, the spectrum may not include the laser wavelength.

The optic selector may comprise a first optic selector arranged to selectively locate a first optic from a first set of different optics and a second optic selector arranged to selectively locate a second optic from a second set of different optics to form the pair of optics for dispersing the incoming light received by the optical input into the spectrum. The first and second optic selectors are mechanically independent such that selecting the first optic from the first set of different optics can be carried out independently from selecting the second optic from the second set of different optics. The first and second optic selectors may be arranged such that different pairs of optics can be formed by pairing an optic of the first set of different optics with each (any) one of a plurality of optics of the second set of different optics. Preferably, each first optic can be paired with each (any) one of a corresponding plurality of optics of the second set of optics. The corresponding plurality of optics of the second set of optics may be the same or different for each optic of the first set of optics. In this way, different pairs of optics can be formed by selecting different combinations of the first optic and the second optic. Each optic of the first set of different optics may be paired with each optic of the second set of different optics. Accordingly, many pairs (sub-sets) can be formed from the optics of the first and second sets.

The first optic selector may comprise a first rotary mount for the first set of different optics, wherein rotation of the first mount to different angular positions selectively locates a different one of the optics as the first optic of the pair of optics. The second optic selector may comprise a second rotary mount for the second set of different optics, wherein rotation of the second mount to different angular positions selectively locates a different one of the optics as the second optic of the pair of optics. The first and/or second selector may comprise a barrel roll optic mount for mounting multiple optics on a single stage.

The first and/or second rotary mount may be arranged to maintain the selected first/second optic in any one of a plurality of different angular positions relative to an optical axis of the incoming light. This arrangement lends itself to a couple of modes of operation.

In a first mode of operation, the first and second rotary mounts are synchronously rotated, changing an angle of the first optic relative to incoming light from the optical input and an angle of the second optic relative to light coming from the first optic (moving the centre wavenumber on each of the first and second optics), to change a portion of the spectrum that falls on the photodetector. The photodetector may comprise a row or column of photodetector elements arranged such that synchronised movement of the first and second rotary mounts moves the spectrum along the row or column of photodetector elements. The data accumulated on each photodetector element may be moved to the next photodetector element of the row or column synchronously with the movement of the rotary mounts such that data on a particular wavenumber is accumulated across multiple photodetector elements. In this way, a spectral range (wavenumber range) of the spectrum that has a spatial extent greater than a width/length of the row/column can be detected for a specified pair of optics. Such a method may extend the detectable spectral range for a specified resolution. In such an arrangement, a read-out register/element of the row or column may be located at an end of the row or column such that spectral values (data) accumulated over multiple photodetector elements of the row or column are progressively moved into the read-out register synchronously with movement of the first and second rotary mounts.

In a second mode of operation, the photodetector comprises a row or column of photodetector elements and a readout register/element located at an end of the row or column and a location of the image projected onto the photodetector of the light profile used to illuminate a sample is adjusted relative to the readout register/element based on a length of the image on the photodetector in a direction perpendicular to a spectral direction. For example, if the light profile is a spot, then the centre of the image of the spot may be located on the photodetector closer to (including in) the readout register/element than if the light profile is a line focus (e.g. produced using a cylindrical lens). This may optimise the readout speed for the spot profile and reduce interference from stray light. The spectral direction is the direction in which the spectrum is dispersed across the photodetector.

The spectroscopy apparatus may comprise a controller for controlling the first and second mounts and, for some embodiments, also the photodetector, to carry out the first mode and/or second mode of operation.

The first set of different optics may be the same or different from the second set of different optics. The first set of different optics may comprise at least one dispersive optic and preferably, a plurality of dispersive optics. The second set of different optics may comprise at least one dispersive optic and preferably, a plurality of dispersive optics. The dispersive optics may comprise diffraction gratings.

The first set or the second set may comprise a mirror. In this way, when the mirror is selected, the spectrum is formed by the other (dispersive) optic of the pair.

Each optic of the pair may be a reflective optic. The incoming light may travel from the optical input to the photodetector along a Z-shaped optical path, wherein each optic of the pair is located at a corner of the Z-shaped optical path. The incoming light may travel between the pair of optics without passing through an aperture, such as a slot and/or pinhole. The incoming light may travel between the pair of optics without passing through a focussing optic. The incoming light may travel between the pair of optics without passing through a focussing optic that focusses the incoming light to an intermediate focussing plane at the aperture. No optical components may be located on the optical path between the pair of optics.

The photodetector may be a CCD or CMOS detector.

According to a second aspect there is provided a method of controlling spectroscopy apparatus according to the first aspect of the invention comprising identifying a selected pair of optics from the set of different pairs and controlling the optic selector to locate the selected pair of optics such that the selected pair disperses incoming light received by the optical input into a spectrum and onto the photodetector; and detecting the spectrum with the photodetector.

The photodetector may comprise an array of photodetector elements and the pair of optics disperses the spectrum across the array of photodetector elements. The method may comprise reading out separate data values from the photodetector, the data values recorded for different wavelengths of incoming light simultaneously incident on different photodetector elements of the photodetector, and associating each data value with a different wavenumber. The different wavenumber associated with each data value may be based on the selected optics and the wavenumbers of the spectrum the selected optics disperse across the photodetector elements when the data value is recorded.

Identifying the selected pair of optics may comprise receiving a user input and identifying the selected pair based on the user input. The user input may identify a required resolution and/or wavenumber range of the spectrum and/or dispersion on the photodetector, and/or a wavelength of illumination light, such as laser light, used to illuminate a sample that generates (for example, through inelastic scattering of the illumination light) the incoming light received by the optical input.

In the embodiment, wherein the first optic selector comprises the first rotary mount and the second rotary mount, the method may comprise controlling the first rotary mount and the second rotary mount to locate the selected pair of optics such that the selected pair disperses incoming light received by the optical input into a spectrum and onto the photodetector.

The method may comprise controlling the first and/or second rotary mount to change an angular position of the selected first/second optic relative to an optical axis of the incoming light such that the spectrum is located at a desired position on the photodetector.

The method may comprise controlling the first and second rotary mounts to synchronously rotate to move the centre wavenumber on each of the first and second optics to change a portion of the spectrum that falls on the photodetector. The photodetector may comprise a row or column of photodetector elements arranged such that synchronised movement of the first and second rotary mounts moves the spectrum along the row or column of photodetector elements. The method may comprise moving data accumulated on each photodetector element to the next photodetector element of the row or column synchronously with the movement of the rotary mounts such that data on a particular wavenumber is accumulated across multiple photodetector elements. In this way, a spectral range (wavenumber range) of the spectrum that has a spatial extent greater than a width/length of the row/column can be detected for a specified pair of optics. Such a method may extend the detectable spectral range for a specified resolution. In such an arrangement, a read-out register/element of the row or column may be located at an end of the row or column such that spectral values (data) accumulated over multiple photodetector elements of the row or column are progressively moved into the read-out register synchronously with movement of the first and second rotary mounts.

The photodetector may comprise a row or column of photodetector elements and a readout register/element located at an end of the row or column, and the method may comprise adjusting a location of the image projected onto the photodetector of the light profile used to illuminate a sample relative to the readout register/element based on a length of the image on the photodetector in a direction perpendicular to a spectral direction. For example, if the light profile is a spot, then the centre of the image of the spot may be located on the photodetector closer to (including in) the readout register/element than if the light profile is a line focus (e.g. produced using a cylindrical lens). This may optimise the readout speed for the spot profile and reduce interference from stray light.

According to a third aspect there is provided a controller for a spectroscopy apparatus according to the first aspect of the invention, the controller arranged to control the spectroscopy apparatus according to the method of the second aspect of the invention.

According to a fourth aspect there is provided a data carrier having instructions thereon, which, when executed by a controller of a spectroscopy apparatus, such as apparatus according to the first aspect of the invention, causes the spectroscopy apparatus to carry out the method of the second aspect of the invention.

The data carrier may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

According to a fifth aspect of the invention there is provided a method of calibrating spectroscopy apparatus comprising an optical input, a first rotary mount for a first optic and a second rotary mount for a second optic, the pair of first and second optics dispersing incoming light received by the optical input into a spectrum, and a photodetector for detecting the spectrum, wherein rotation of the first mount adjusts an angular position of the first optic relative to an optical axis of incoming light from the optical input and rotation of the second mount adjusts an angular position of the second optic relative to light coming from the first optic, the method comprising, for a plurality of relative angular positions of the first optic and second optic, determining wavenumbers of the spectrum detectable by the photodetector.

The first optic may be a first diffraction grating and the second optic may be a second diffraction grating.

The method may comprise locating the first optic in a zero-order angular position in which the zero-order of the incoming light is directed to the second optic. A plurality of different angular positions of the second optic is then calibrated by measuring a spectrum on the photodetector for each different angular position of the second optic. A first set of physical parameters may be determined from the measured spectra.

The method may comprise locating the second optic in a zero-order angular position in which the zero-order of the incoming light is directed to a centre of the photodetector. A plurality of different angular position of the first optic is then calibrated by measuring a spectrum on the photodetector for each different angular position of the first optic. A second set of physical parameters may be determined from the measured spectra.

The method may comprise determining an average set of physical parameters from the first and second set of physical parameters.

The determined physical parameters may be used (sufficient) to predict a wavenumber at each photodetector element of the photodetector for a plurality of given angular positions of the first and second optics.

The method may comprise refining the determined physical parameters by measuring a spectrum on the photodetector (for example generated using a calibration lamp) for a set of given angular positions of the first and second optics, comparing the measured spectrum to a predicted spectrum predicted using the determined physical parameters and refining the determined physical parameters based on the comparison. The comparison may be between a predicted wavenumber of a photodetector element and a measured wavenumber for that photodetector element. The measured wavenumber may be based on the known spectrum produced by the calibration lamp.

According to a further aspect of the invention there is provided spectroscopy apparatus comprising an optical input; a first rotary mount for a first optic and a second rotary mount for a second optic; the pair of first and second optics dispersing incoming light received by the optical input into a spectrum; a photodetector for detecting the spectrum; and a controller for controlling movement of the first and second mounts, the controller arranged to cause synchronous rotation of the first and second rotary mounts, changing an angle of the first optic relative to incoming light from the optical input and an angle of the second optic relative to light coming from the first optic, to change a portion of the spectrum that falls on the photodetector. The photodetector may comprise a row or column of photodetector elements arranged such that the synchronised rotation of the first and second rotary mounts moves the spectrum along the row or column of photodetector elements. The controller may control the photodetector such that data accumulated on each photodetector element is moved to the next photodetector element of the row or column synchronously with the rotation of the rotary mounts such that data on a particular wavenumber is accumulated across multiple photodetector elements.

According to a further aspect of the invention there is provided spectroscopy apparatus comprising an optical input; a first rotary mount for a first optic and a second rotary mount for a second optic; the pair of first and second optics dispersing incoming light received by the optical input into a spectrum; a photodetector for detecting the spectrum comprising a row or column of photodetector elements and a readout register/element located at an end of the row or column; and a controller for controlling movement of the first and second mounts to locate an image projected onto the photodetector of the light profile used to illuminate a sample relative to the readout register/element based on a length of the image on the photodetector in a direction perpendicular to a spectral direction.

For example, if the light profile is a spot, then the centre of the image of the spot may be located on the photodetector closer to (including in) the readout register/element than if the light profile is a line focus (e.g. produced using a cylindrical lens). This may optimise the readout speed for the spot profile and reduce interference from stray light.

A length of the image on the photodetector of different light profiles may be determined from calibration. The light profiles may comprise a spot focus and a line focus. The controller may control the movement of the first and second mounts based on a signal indicating the type of light profile being used. For example, the spectroscopy apparatus may generate the signal based on a selection of a focussing lens by the user.

According to a further aspect of the invention there is provided a spectroscopy apparatus comprising an optical input, a first optic mounted to be located or locatable to disperse light received from the optical input into a first spectrum, a second optic mounted to be located or locatable to receive the first spectrum and disperse the first spectrum into a second spectrum, and a photodetector arranged to detect the second spectrum.

The first optic may be a first diffraction grating. The second optic may be a second diffraction grating. The first optic may be a reflective dispersive element. The second optic may be a reflective dispersive element. The first optic may be a reflective diffraction grating. The second optic may be a reflective diffraction grating. The incoming light may travel from the optical input to the photodetector along a Z-shaped optical path, wherein each optic of the pair is located at a corner of the Z-shaped optical path.

No optical component may be located in an optical path between the first optic and the second optic.

### DESCRIPTION OF THE DRAWINGS

FIG. 1 is schematic of spectroscopy apparatus according to an embodiment of the invention;

FIG. 2 is a schematic view of part of an optical train used to deliver light from the sample to a photodetector;

FIG. 3a is a perspective view of a rotary optic mount of the spectroscopy apparatus from a first direction;

FIG. 3b is a perspective view of a rotary optic mount of the spectroscopy apparatus from a second direction;

FIG. 4 is a schematic illustrating a method of extending a spectral range detectable using a pair of gratings using a first mode of operation; and

FIG. 5 is a schematic illustrating a method of using the apparatus in a second mode of operation.

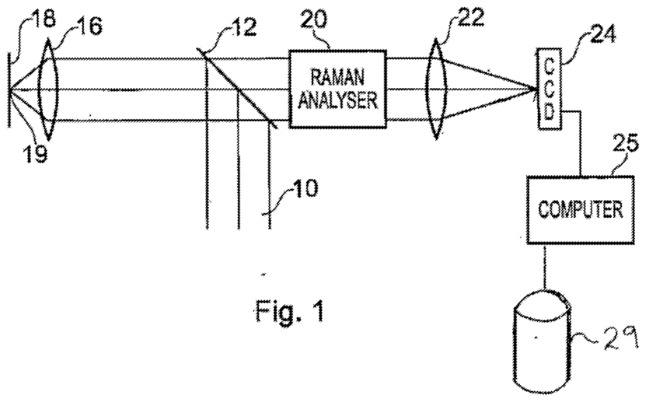

### DESCRIPTION OF EMBODIMENTS

Referring to the Figures, apparatus according to the invention comprises a Raman spectrometer connected to a computer 25 that has access to memory 29.

The Raman spectrometer comprises a source of an excitation beam, in this embodiment an input laser beam 10, reflected through 90 degrees by a dichroic filter 12 (referred to herein as a Rayleigh filter), placed at 45 degrees to the optical path. Alternatively a holographic dichroic filter may be placed at a low angle of incidence such as 10 degrees. The laser beam then passes to an objective lens 16, which focuses it to a spot at its focal point 19 on a sample 18. Light is scattered by the sample at this illuminated spot, and is collected by the objective lens 16 and collimated into a parallel beam which passes back to the dichroic filter 12. The filter 12 rejects Rayleigh scattered light having the same frequency as the input laser beam 10, and transmits the Raman scattered light. The Raman scattered light then passes to a spectral analyser 20.

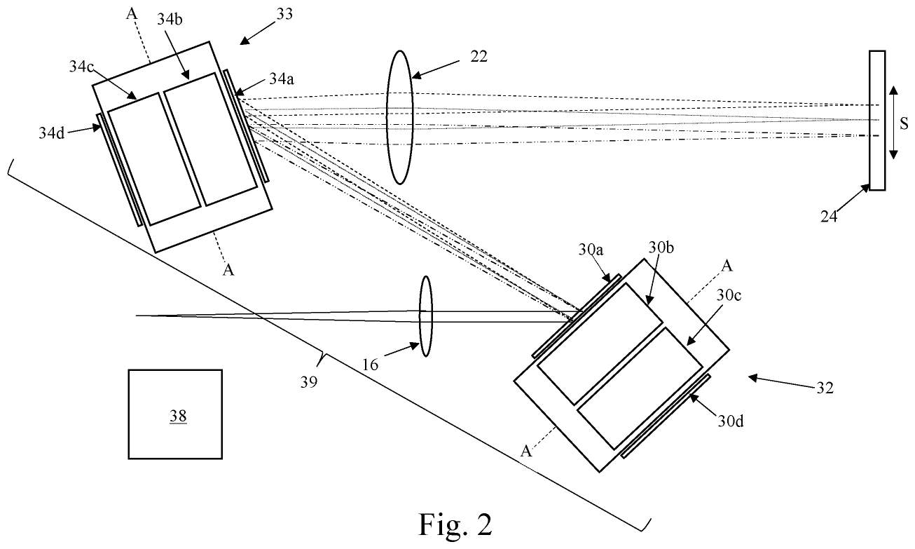

The spectral analyser 20 comprises dispersive elements, such as diffraction gratings, as described in more detail below with reference to FIG. 2. The light from the analyser 20 is focused by a lens 22 onto a suitable photodetector 24. A photodetector array is preferred. In the present embodiment the detector 24 is a charge-coupled device (CCD), which consists of a two-dimensional array of pixels 28, and which is connected to the computer 25 which acquires data from each of the pixels 28 and analyses it as required. The analyser 20 produces a spectrum spread out in a line along the CCD 24.

Samples 18 may be mounted on an X-Y table (not shown) so that the focus 19 can be scanned across it in X and Y directions, e.g. under control of the computer 25. A plurality of spectra can then be gathered, each spectrum corresponding to a different point on the sample. A map can then be generated based upon properties of the sample determined from the collected spectra.

The focus 19 may be a point/spot or a line. A line focus may be formed using a cylindrical lens 16.

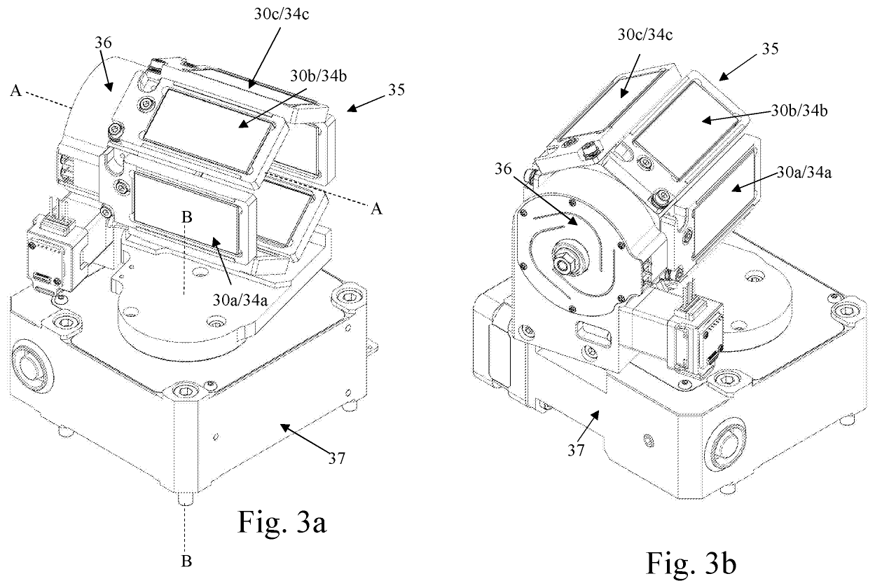

Referring to FIGS. 2 and 3, the objective lens 16 acts as an optical input for receiving light scattered/emitted from the sample as a result of the illumination of the sample by the spot or line focus. The spectral analyser comprises an optic selector 39 arranged to selectively locate a pair of optics 30, 34 selected from a set of different pairs such that the pair of optics disperses incoming light received by the optical input 16 into a spectrum that is directed to the photodetector 24. In this embodiment, the optic selector 39 comprises a first optic selector 32 arranged to selectively locate a first optic 30 from a first set of different optics 30a, 30b, 30c, 30d and a second optic selector 33 arranged to selectively locate a second optic 34 from a second set of different optics 34a, 34b, 34c, 34d to form the pair of optics for dispersing the incoming light received by the optical input 16 into the spectrum. In FIG. 3 four optics 30a, 30b, 30c, 30d; 34a, 34b, 34c, 30d of each set is shown. However, it will be understood that each set may comprise two or more optics. In the optic selector shown in FIG. 3, locations for six optics are provided.

Referring to FIG. 3, in this embodiment, each optic selector 32, 33 comprises a rotary mount, wherein rotation of the mount about first axis A-A to different angular positions selectively locates a different one of the optics 30a, 30b, 30c, 30d; 34a, 34b, 34c. 34d of the corresponding set in the path of the light from the optical input 16 to the photodetector 24. The rotary mount comprises a support 35 mounted for rotation about the first axis A-A that provides locations for mounting the optics. The support 35 may have a regular polygonal cross-section, in this embodiment hexagonal, having faces that provide the locations for the optics. A motor 36 is configured to drive rotation of the support 35 about the first axis A-A.

The support 35 is mounted for rotation on a base 37. Housed within base 37 is a motor (not shown) for rotating the support 35 about second axis B-B. Second axis B-B is perpendicular to first axis A-A.

The first set of optics comprises a plurality of diffraction gratings 30a, 30b, 30c, each diffraction grating of the first set having a different grating constant, and a mirror 39d. The second set of optics comprises a plurality of diffraction gratings 34a, 34b, 34c, 30d each diffraction grating of the second set having a different grating constant.

In use, the first optic selector 32 is arranged in the apparatus such that one of the diffraction gratings 30a, 30b, 30c or the mirror 30d can be positioned to receive light from the optical input 16 and disperse or reflect the light such that the dispersed/reflected light is directed to an optic 34a, 34b, 34c, 34d of the second optic selector 33. The second optic selector 33 is arranged in the apparatus such that one of the diffraction gratings 34a, 34b, 34c, 34d can be positioned to receive dispersed/reflected light from the optic 30a, 30b, 30c, 30d of the first optic selector 33 and modify dispersion of the dispersed light such that dispersed light is directed to the photodetector 24. The dispersed light from the optic 34a, 34b, 34c, 34d of the second optic selector 33 is focussed by a lens 22 on to the photodetector 24. The pair of first and second optics 30, 34 forms a Z-shaped optical path from the lens 16 at the optical input 16 to the lens 22 on the output to the photodetector 24.

The motors 36, 37 are controlled by controller 38. In use, the controller 38 receives an input indicative of a resolution and/or wavenumbers of the spectrum to be detected by photodetector 24. Based on the indicated resolution and/or wavenumbers, the controller drives the motor 36 of each optic selector 32, 33 to locate the required optic 30a, 30b, 30c, 30d; 34a, 34b, 34c, 34d in the optical path to form a pair of first and second optics for dispersing the light into a spectrum such that the required wavenumbers of the spectrum with the required resolution fall on the photodetector 24. The controller 38 may use a look-up table to determine the required optics 30a, 30b, 30c; 34a, 34b, 34c based on the indicated resolution and/or wavenumbers. Alternatively, the user may input into the controller 38 the required optics 30a, 30b, 30c; 34a, 34b, 34c. The resolution and/or wavenumber and/or dispersion may be selected based on what is most suited to the application of the spectroscopy.

In addition, for each optic 30a, 30b, 30c, 30d; 34a, 34b, 34c, 34d of a pair it is possible to use a non-zero order (−3, −2, −1, +1, +2, +3, etc) or zeroth order position by adjusting the angle of the diffraction grating 30a, 30b, 30c; 34a, 34b, 34c, 30d to the incoming light using motor 37 to provide different combinations of additive and subtractive dispersions. This may further increase the range of wavenumbers and resolutions of a spectrum on the photodetector 24. The non-zero order or zeroth order position for the first optic is a position in which the first optic directs that order of the incoming light to the second optic. The non-zero order or zeroth order position for the second optic is a position in which the second optic directs that order of the incoming light to the photodetector 24.

Furthermore, wavelength specific diffraction gratings may be provided such that a diffraction grating can be selected based on the wavenumbers of interest to optimise diffraction efficiency.

The computer 25 is programmed with software code on a suitable medium, such as memory 29, comprising instructions, which when executed by a processor of computer 25 cause the computer 25 to analyse the data from the photodetector 24. Alternatively, the data on the Raman spectrum/spectra obtained may be transferred to a separate computer having such software for this analysis. In either case, the computer 25 receives information on the optics selected by the first and second optic selector 32, 33 for generating the spectral data such that the analysis correctly attributes the intensity values to the appropriate wavenumbers. The intensity values determined are stored in the computer concerned, and may be further processed and output or displayed to show the concentrations of the components in the sample/samples.

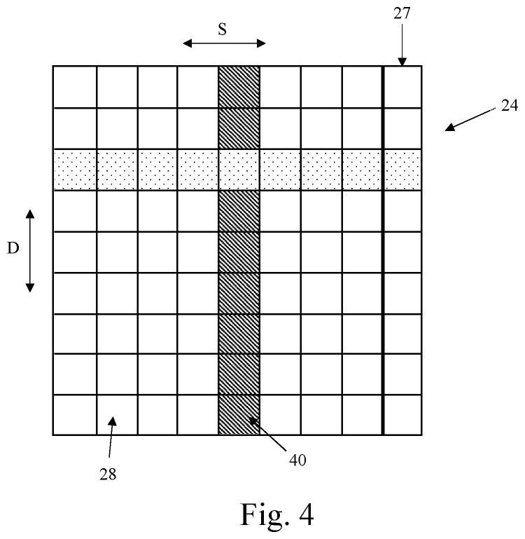

Referring to FIG. 4, the photodetector 24 comprises a 2-dimensional array of photodetector elements 28 and a readout register 27. In one embodiment, the photodetector 24 is oriented such that the readout register is located at the end of a row or column in the spectral direction S (a direction in which the spectrum is dispersed by the pair of optics 30a, 30b, 30c, 30d; 34a, 34b, 34c, 34d). A direction perpendicular to the spectral direction S is a spatial direction D. In the case of a line focus 40, a spectrum is generated across each row/column of the photodetector 24 in the spectral direction S for different given regions of the line focus 40. For a spot focus, a spectrum may only be generated across fewer rows/columns of the photodetector 24 in the spectral direction S, such as a single row/column of the photodetector 24. In use, the first optic selector 32 and the second optic selector 33 are synchronously moved about second axis B-B to change an angle of each selected optic 30a, 30b, 30c, 30d; 34a, 34b, 34c, 34d in the optical path to move the centre wavenumbers on each grating and therefore, shifting the wavenumbers of the spectrum that land on the photodetector 24. Synchronous with this movement of the spectrum on the photodetector 24, the charge held by each photodetector element 28 is shifted to another photodetector element 28 in the spectral direction S towards the redout register 27. The charge is shifted (clocked) in synchronicity with the movement of the spectrum on the photodetector 24 such that charge for a particular wavenumber collected by a first photodetector element continues to accumulate but on different photodetector elements 28 of the photodetector 24. When accumulated data for a particular wavenumber is shifted into the readout register 27, it is readout out to computer 25. For a line focus, multiple values for each wavenumber are read out corresponding to different spatial positions along the line focus 40. For a spot focus a single value may be readout for each wavenumber. This method extends the spectral range detectable at a particular resolution using a particular pair of optics 30a, 30b, 30c, 30d; 34a, 34b, 34c, 34d without having to stitch separately collected spectral ranges together.

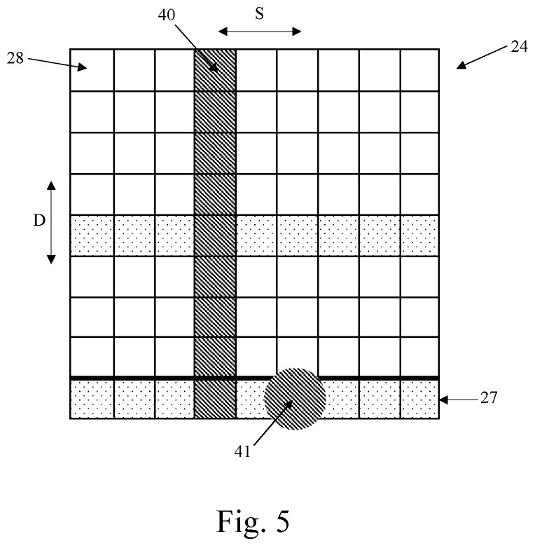

Referring to FIG. 5, in an alternative embodiment, the photodetector 24 is oriented such that the readout register 27 is located at the end of a row or column in the spatial direction D. A direction perpendicular to the spatial direction D is the spectral direction S. For a line focus 40, each selected optic 30a, 30b, 30c, 30d; 34a, 34b, 34c, 34d is located about first axis A-A such that an end of the line focus is located in the readout register 27. For a spot focus, a location of each selected optic 30a, 30b, 30c, 30d; 34a, 34b, 34c, 34d is adjusted about first axis A-A such that the centre of the image in the spatial direction is located in the readout register 27. In this way, readout speed is increased compared to not adjusting the centre location of the focus in the spatial direction when switching between line and spot focus.

For both the methods described above, the apparatus should be calibrated for different angular positions of each rotary mount about axes A-A and B-B. The calibration about axes A-A establishes a location of the focus on the photodetector in the spatial direction for different angular positions of the rotary mounts about axes A-A. The calibration about axes B-B establishes the wavenumbers on the photodetector in the spectral direction for different angular positions of the rotary mounts about axes B-B. These calibrations may be carried out by directing laser light into the optical input 16 and determining a location of the laser spot on the photodetector 24.

A first one of diffraction gratings 30a, 30b, 30c is positioned at an angular position relative to an optical path of the incoming light such that the zero-order is directed along the optical path to the selected second optic 34a, 34b, 34c, 34d. This position of the zero-order for diffraction grating 30a, 30b, 30c may be determined by first orienting the diffraction grating so that is reflects the incoming light straight back to the optical input 16. Rotating the diffraction grating from this position by an angle corresponding to the known angle from the incoming light to the optical path between the first and second optic (in this embodiment 15°) from this position will approximately direct the zero-order to the second optic. Alternatively, a target can be located along the path between the first and second optic and the method can comprise detecting when the zero-order for the incoming light is directed onto the target. The incoming light may be a laser beam. This process may be repeated for each one of the diffraction gratings 30a, 30b, 30c for the first optic selector 32 such that a position is determined for each diffraction grating 30a, 30b, 30c at which the diffraction grating 30a, 30b, 30c directs a zero-order along the optical path to the selected second optic 34a, 34b, 34c, 34d.

Zero-order positions for each of the diffraction gratings 34a, 34b, 34c, 34d of the second optic selector 33 are then determined. With a diffraction grating 30a, 30b, 30c positioned to direct a zero-order of the incoming light to the diffraction grating 34a, 34b, 34c, 34d, a position of the diffraction grating 34a, 34b, 34c, 34d to the incoming light is adjusted until a zero-order of the light is directed to a centre of the photodetector 24.

Movement of spectrum in the spectral direction, S, on the photodetector 24 as a result of rotation of the diffraction grating about axis B-B may then be calibrated. A calibration light source, such as a neon light, is used to generate light having a known spectrum, with clearly defined emission lines. This light is received by the optical input 16. One of the first and second diffraction gratings 30a, 30b, 30c; 34a, 34b, 34c, 34d is rotated to different positions, shifting the known spectrum on the photodetector 24, whilst the other of the first and second diffraction gratings 30a, 30b, 30c; 34a, 34b, 34c, 34d is maintained in the zero-order position. Intensity values are recorded from the photodetector elements for each position, and a wavenumber shift (wavenumber/pixel) is determined for that rotation of the diffraction grating 30a, 30b, 30c; 34a, 34b, 34c, 34d. This is repeated for multiple positions of the diffraction grating 30a, 30b, 30c; 34a, 34b, 34c, 34d and for different ones of the diffraction gratings 30a, 30b, 30c; 34a, 34b, 34c, 34d of that optic selector 32, 33. This process is then repeated but for diffraction gratings 34a, 34b, 34c, 34d; 30a, 30b, 30c of the other optic selector 32, 33.

From the wavenumber shift, a set of physical parameters of the spectroscopy system are fitted. This will result in some physical parameters being overfitted due to some physical features, such as lens distortion and focal lengths, appearing differently in each calibration. Accordingly, an average (mean) set of physical parameters may be determined from those that are found. This average set of physical parameters can be used to predict the wavenumber at any given pixel for any given angular position of each diffraction grating 30a, 30b, 30c; 34a, 34b, 34c, 34d.

Using the average set of physical parameters, a calibration can be run for the combined grating system to determine a final (refined) set of physical parameters. This may be carried out by recording spectra on the photodetector 24 for different positions of the diffraction gratings 30a, 30b, 30c; 34a, 34b, 34c, 34d of each pair. The spectra may be created using the calibration lamp.

It will be understood that modifications and alterations may be made to the above-described embodiments without departing from the scope of the invention as defined herein. For example, the rotation of the support 35 about the first and/or second axes may not be motorised. The second optic selector 33 rather than the first optic selector 32 may comprise the mirror. Rather than two rotary axes, the optic selector may comprise a single rotary axis B-B, wherein the plurality of optics 30a, 30b, 30c, 30d; 34a, 34b, 34c, 34d are mounted about the axis B-B such that rotation of the optic support about the axis B-B changes the optic 30a, 30b, 30c, 30d; 34a, 34b, 34c, 34d in the optical path. Motorised linear mechanism may also be used to change the optics, whilst rotation about B-B sets the angle of the optic to the incoming light. A potential disadvantage of an optic selector with a single rotary axis is that a position of the image on the photodetector for line and spot focus cannot be altered for enhancing data collection rates.

1. A Raman spectroscopy apparatus comprising an optical input; an optic selector arranged to selectively locate a pair of optics selected from a set of different pairs such that the pair of optics disperses incoming light received by the optical input into a spectrum; and
a photodetector arranged to detect the spectrum, wherein selecting a different pair of optics from the set changes the spectrum detectable by the photodetector.

2. A Raman spectroscopy apparatus according to claim 1, wherein the incoming light travels between the pair of optics without passing through a focussing optic that focusses the incoming light to an intermediate focussing plane at an aperture.

3. A Raman spectroscopy apparatus according to claim 1, wherein the photodetector comprises an array of photodetector elements and the pair of optics disperses the spectrum across the array of photodetector elements.

4-8. (canceled)

9. A Raman spectroscopy apparatus according to claim 1, wherein the change in the spectrum comprises a shift in wavenumbers of the spectrum and/or a change in resolution of the spectrum and/or change in dispersion of the spectrum.

10. A Raman spectroscopy apparatus according to claim 1, wherein the optic selector comprises a first optic selector arranged to selectively locate a first optic from a first set of different optics and a second optic selector arranged to selectively locate a second optic from a second set of different optics to form the pair of optics for dispersing the incoming light received by the optical input into the spectrum.

11. A Raman spectroscopy apparatus according to claim 10, wherein the first and second optic selectors are arranged such that different pairs of optics can be formed by pairing an optic of the first set of different optics with each one of a plurality of optics of the second set of different optics.

12. A Raman spectroscopy apparatus according to claim 10, wherein the first and second optic selectors are arranged such that each optic of the first set of different optics can be paired with each optic of the second set of different optics.

13. A Raman spectroscopy apparatus according to claim 10, wherein the first optic selector comprises a first rotary mount for the first set of different optics.

14. A Raman spectroscopy apparatus according to claim 13, wherein the first rotary mount is arranged such that rotation of the first mount to different angular positions selectively locates a different one of the optics as the first optic of the pair of optics.

15. A Raman spectroscopy apparatus according to claim 13, wherein the first rotary mount is arranged to maintain the selected first optic in any one of a plurality of different angular positions relative to an optical axis of the incoming light.

16-18. (canceled)

19. A Raman spectroscopy apparatus according to claim 13, wherein the second optic selector comprises a second rotary mount for the second set of different optics, the second rotary mount arranged to maintain the selected second optic in any one of a plurality of different angular positions relative to an optical axis of the incoming light, the spectroscopy apparatus comprising a controller for controlling the first and second mounts.

20. A Raman spectroscopy apparatus according to claim 19, wherein the controller is arranged to control the first and second rotary mounts to rotate synchronously, changing an angle of the first optic relative to incoming light from the optical input and an angle of the second optic relative to light coming from the first optic, to change a portion of the spectrum that falls on the photodetector.

21. A Raman spectroscopy apparatus according to claim 20, wherein the photodetector comprises a row or column of photodetector elements arranged such that synchronised movement of the first and second rotary mounts moves the spectrum along the row or column of photodetector elements.

22. A Raman spectroscopy apparatus according to claim 21, wherein the controller is arranged to control the photodetector such that the data accumulated on each photodetector element is moved to the next photodetector element of the row or column synchronously with the movement of the rotary mounts such that data on a particular wavenumber is accumulated across multiple photodetector elements.

23-26. (canceled)

27. A Raman spectroscopy apparatus according to claim 1, wherein the first set of different optics comprises at least one dispersive optic.

28. (canceled)

29. A Raman spectroscopy apparatus according to claim 27, wherein the second set of different optics comprises at least one dispersive optic.

30-32. (canceled)

33. A Raman spectroscopy apparatus according to claim 1, wherein the incoming light travels from the optical input to the photodetector along a Z-shaped optical path, wherein each optic of the pair is located at a corner of the Z-shaped optical path.

34. A method of controlling Raman spectroscopy apparatus according to claim 1 comprising identifying a selected pair of optics from the set of different pairs and controlling the optic selector to locate the selected pair of optics such that the selected pair disperses incoming light received by the optical input into a spectrum and onto the photodetector; and detecting the spectrum with the photodetector.

35. A method according to claim 34, wherein the photodetector comprises an array of photodetector elements and the pair of optics disperses the spectrum across the array of photodetector elements, and the method comprises reading out separate data values from the photodetector, the data values recorded for different wavelengths of incoming light simultaneously incident on different photodetector elements of the photodetector, and associating each data value with a different wavenumber.

36-43. (canceled)

44. A non-transient data carrier having instructions thereon, which, when executed by a controller of a Raman spectroscopy apparatus causes the Raman spectroscopy apparatus to carry out the method of claim 34.
